(19) United States
(12) Patent Application Publication
(10) Pub. No.: US 2017/0041392 A1
(43) Pub. Date: Feb. 9, 2017

(54) METHOD OF DISTRIBUTING A FILE AND A COMPUTING SYSTEM EMPLOYING SAME

(71) Applicant: SMART Technologies ULC, Calgary (CA)

(72) Inventor: Thibaut VOLT, New Westminster (CA)

(21) Appl. No.: 14/818,047

(22) Filed: Aug. 4, 2015

(51) Int. Cl. H04L 29/08

(52) U.S. Cl. CPC H04L 67/1097; H04L 67/06; H04L 67/02; H04L 67/146

(57) ABSTRACT

A computerized method and system are disclosed for distributing a file opened on a first computing device. The first computing device identifies and saves the file to a file-download location; starts a file-distribution service for downloading the copy of the file from the file-download location; generates a URL indicating the file-download location; generates a presentation, such as a QR code, of the URL; and presents the generated presentation, e.g., on a display thereof. At least a second computing device acquires the QR code; obtains the URL from the obtained QR code, and uses the URL to download the file from the file-download location.

### FIELD OF THE DISCLOSURE

The present invention relates generally to a computing system, and in particular to a method of distributing a file and a computing system employing same.

### BACKGROUND

Computing systems such as computerized collaboration systems are known. Generally, a collaboration system comprises a plurality of computing devices interconnected via a communication network for users to collaborate with each other. For example, SMART Meeting Pro™ offered by SMART Technologies ULC of Calgary, Alberta, Canada, allows a group of users at different locations to establish a collaboration session using their computing devices via a communication network. During collaboration, SMART Meeting Pro™ establishes audio, video and data communication between users via one or more servers in the network. Users in the collaboration session may share one or more whiteboard pages or a user's computer screen. Users in the collaboration session may inject digital ink annotation, images and/or other multimedia contents on the shared whiteboard page or computer screen, share audio/video stream to other users in the collaboration session, and/or send text message to other users in the collaboration session.

Other collaboration systems, such as Cisco WebEx®, Citrix® GoToMeeting®, Microsoft® Lync®, etc., are also available. These collaboration systems allow users in a collaboration session to share text, images and audio/video streams.

File sharing is often required in collaboration. The above mentioned collaboration systems provide various file sharing methods, for example, by emailing one or more files to relevant users before a collaboration session is started or after a collaboration session is finished. As another example, in some collaboration systems, users may upload files to a shared storage associated with a collaboration session before or during the collaboration session to allow other users in the collaboration session to download.

In many situations a user may open a file for collaboration, and want to distribute the opened file to other users. With above mentioned methods, the user has to save the file (if it has been modified), and then email the file to other users or upload the file to the shared storage, causing unnecessary overhead or burden to users.

It is therefore an object to provide a novel method of sharing a file and a computing system employing same.

### SUMMARY

According to one aspect of this disclosure, there is provided a computerized method of distributing an opened file on a first computing device. The method comprises: on the first computing device, upon receiving a command to distribute the file, starting a file-distribution service for downloading a copy of the file from a file-download location; generating a file-download location identifier, the file-download location identifier indicating the file-download location; generating a representation of the file-download location identifier; and presenting the representation for distributing the opened file.

In some embodiments, the method further comprises: on a second computing device, acquiring the representation; obtaining said file-download location identifier from the representation; and downloading said copy of the file from the file-download location indicated by the file-download location identifier.

In some embodiments, the file-distribution service is a web service using the Hypertext Transfer Protocol (HTTP) or File Transfer Protocol (FTP) protocol.

In some embodiments, the file-download location identifier is a Universal Resource Locator (URL) of the file-download location.

In some embodiments, the representation of the file-download location identifier is a visual representation; and said acquiring the representation further comprises: acquiring the representation using an imaging device.

In some embodiments, the representation of the file-download location identifier is a QR code.

In some embodiments, said opened file comprises at least a working copy and a stored copy, and the method further comprises: saving one of the working copy and the stored copy to the file-download location.

In some embodiments, said saving one of the working copy and the stored copy to the file-download location comprises: determining whether the working copy is different from the stored copy; and if the working copy is different from the stored copy, saving a copy of the working copy to the file-download location.

In some embodiments, said saving one of the working copy and the stored copy to the file-download location comprises: saving a copy of the stored copy of the file to the file-download location regardless whether or not the working copy of the file is different from the stored copy.

In some embodiments, said saving one of the working copy and the stored copy to the file-download location comprises: determining whether the working copy is different from the stored copy; and if the working copy is different from the stored copy, prompting user whether the working copy or the stored copy shall be distributed; and in response of a user command indicating a user-selected copy for distribution, saving the user-selected copy to the file-download location.

In some embodiments, the method further comprises: on the first computing device, after a copy of the file has been saved to the file-download location, determining that the file has been modified after said copy of the file has been saved to the file-download location; and saving the working copy of the file to the file-download location.

In some embodiments, the file-download location is a predetermined file-download location.

In some embodiments, the file-download location is a dynamically generated file-download location.

In some embodiments, the file-download location is a file folder.

In some embodiments, the file-download location is a file folder in a memory local to the first computing device.

In some embodiments, the file-download location is a file folder in a memory remote to the first computing device.

According to another aspect of this disclosure, there is provided a computing system for distributing a file. The system comprises: at least a first computing device, said first computing device comprising: a memory; a networking structure; and a processing structure functionally coupled to said memory and networking structure, wherein said processing structure executes computer-executable code for: receiving a command to distribute the file; starting a file-distribution service for downloading a copy of the file from a file-download location; generating a file-download location identifier, said file-download location identifier indicating the file-download location; generating a representation of the file-download location identifier; and presenting the representation for distributing the opened file.

In some embodiments, the system further comprises at least a second computing device, said at least a second computing device comprising: a memory; a networking structure; and a processing structure functionally coupled to said memory and networking structure; wherein said processing structure executes computer-executable code for: acquiring the representation; obtaining said file-download location identifier from the representation; and downloading said copy of the file from the file-download location indicated by the file-download location identifier.

In some embodiments, the file-distribution service is a web service using the HTTP or FTP protocol.

In some embodiments, the file-download location identifier is a URL of the file-download location.

In some embodiments, the representation of the file-download location identifier is a visual representation; and said acquiring said representation further comprises: acquiring the representation using an imaging device.

In some embodiments, the representation of the file-download location identifier is a QR code.

In some embodiments, said opened file comprises at least a working copy and a stored copy; and the processing structure of the first computing device further executes computer-executable code for: saving one of the working copy and the stored copy to the file-download location.

In some embodiments, said saving one of the working copy and the stored copy to the file-download location comprises: determining whether the working copy is different from the stored copy; and if the working copy is different from the stored copy, saving a copy of the working copy to the file-download location.

In some embodiments, said saving one of the working copy and the stored copy to the file-download location comprises: saving a copy of the stored copy of the file to the file-download location regardless whether or not the working copy of the file is different from the stored copy.

In some embodiments, said saving one of the working copy and the stored copy to the file-download location comprises: determining whether the working copy is different from the stored copy; and if the working copy is different from the stored copy, prompting user whether the working copy or the stored copy shall be distributed; and in response of a user command indicating a user-selected copy for distribution, saving the user-selected copy to the file-download location.

In some embodiments, the processing structure of the first computing device further executes computer-executable code for: after a copy of the file has been saved to the file-download location, determining that the file has been modified after said copy of the file has been saved to the file-download location; and saving the working copy of the file to the file-download location.

In some embodiments, the file-download location is a predetermined file-download location.

In some embodiments, the file-download location is a dynamically generated file-download location.

In some embodiments, the file-download location is a file folder.

In some embodiments, the file-download location is a file folder in a memory local to the first computing device.

In some embodiments, the file-download location is a file folder in a memory remote to the first computing device.

According to another aspect of this disclosure, there is provided a non-transitory computer-readable storage device comprising computer-executable instructions for distributing an opened file. The instructions, when executed, cause a first processor to perform actions comprising: starting a file-distribution service for downloading a copy of the file from a file-download location; generating a file-download location identifier, said file-download location identifier indicating the file-download location; generating a representation of the file-download location identifier; and presenting the representation for distributing the opened file.

In some embodiments, the computer-readable storage device further comprises computer-executable instructions, when executed, cause a second processor to perform actions comprising: acquiring the representation; obtaining said file-download location identifier from the representation; and downloading said copy of the file from the file-download location indicated by the file-download location identifier.

In some embodiments, the file-distribution service is a web service using the HTTP or FTP protocol.

In some embodiments, the file-download location identifier is a URL of the file-download location.

In some embodiments, the representation of the file-download location identifier is a visual representation; and said acquiring said representation further comprises: acquiring the representation using an imaging device.

In some embodiments, the representation of the file-download location identifier is a QR code.

In some embodiments, said opened file comprises at least a working copy and a stored copy; and the instructions, when executed, cause the first processor to perform further actions comprising: saving one of the working copy and the stored copy to the file-download location.

In some embodiments, said saving one of the working copy and the stored copy to the file-download location comprises: determining whether the working copy is different from the stored copy; and if the working copy is different from the stored copy, saving a copy of the working copy to the file-download location.

In some embodiments, said saving one of the working copy and the stored copy to the file-download location comprises: saving a copy of the stored copy of the file to the file-download location regardless whether or not the working copy of the file is different from the stored copy.

In some embodiments, said saving one of the working copy and the stored copy to the file-download location comprises: determining whether the working copy is different from the stored copy; and if the working copy is different from the stored copy, prompting user whether the working copy or the stored copy shall be distributed; and in response of a user command indicating a user-selected copy for distribution, saving the user-selected copy to the file-download location.

In some embodiments, the instructions, when executed, cause the first processor to perform further actions comprising: after a copy of the file has been saved to the file-download location, determining that the file has been modified after said copy of the file has been saved to the file-download location; and saving the working copy of the file to the file-download location.

In some embodiments, the file-download location is a predetermined file-download location.

In some embodiments, the file-download location is a dynamically generated file-download location.

In some embodiments, the file-download location is a file folder.

In some embodiments, the file-download location is a file folder in a memory local to the first processor.

In some embodiments, the file-download location is a file folder in a memory remote to the first processor.

### BRIEF DESCRIPTION OF THE DRAWINGS

FIG. 1 is a perspective view of an example of a computing system, according to an embodiment of the present disclosure;

FIG. 2 shows an example of a computing device of the computing system of FIG. 1;

FIG. 3 shows the hardware structure of a computing device of the computing system of FIG. 1;

FIG. 4 shows a simplified software architecture of a computing device of the computing system of FIG. 1.

FIGS. 5A to 5D show a flowchart illustrating the steps of a process for distributing a file;

FIGS. 6A to 6F show an example of distributing an opened file;

FIG. 7 shows an example of distributing an opened file, according to an alternative embodiment; and

FIG. 8 shows an example of distributing an opened file, according to yet another embodiment.

### DETAILED DESCRIPTION

Herein, methods for distributing an opened file are described. In an embodiment, a file opened in an application of a first computing device may be distributed to a second computing device without closing the file or exiting the application. As follows, the system supporting the process and operation are set forth before various embodiments for distributing an opened file are described.

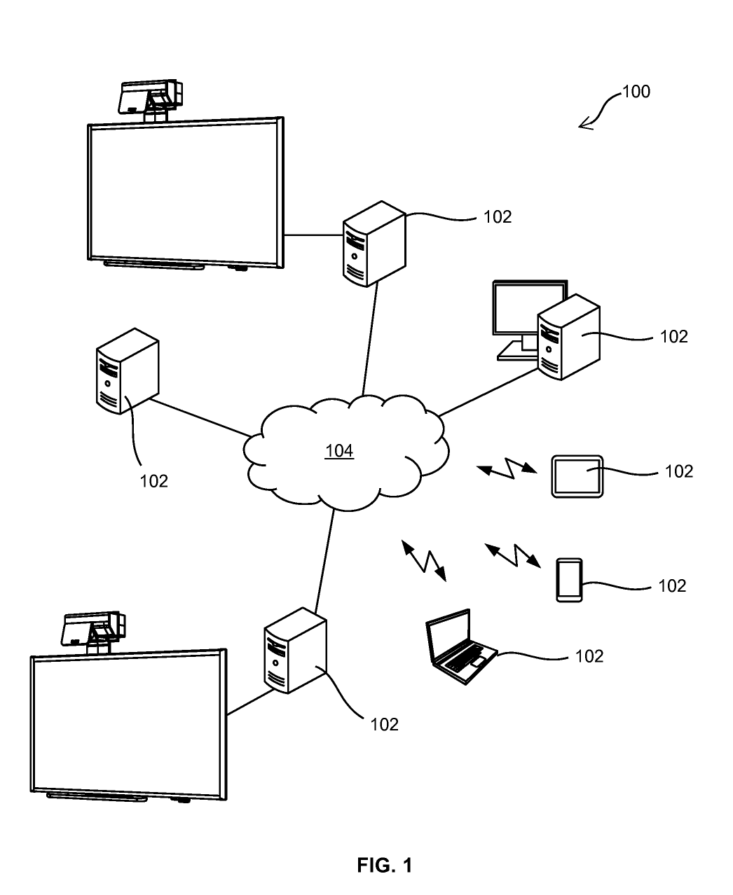

Turning now the FIG. 1, a computing system is shown and is generally identified by reference numeral 100. In this embodiment, the computing system 100 comprises two or more computing devices 102, such as server computers, computer presentation systems having interactive whiteboards, desktop computers, laptop computers, tablets, smartphones, Personal Digital Assistants (PDAs) and the like, interconnected by a network 104, such as Internet, a local area network (LAN), a wide area network (WAN) or the like, via suitable wired and wireless networking connections. Generally, the computing devices 102 may be classified as server computers running one or more server programs, and client computing devices running one or more client application programs and for users to use.

Depending on implementation, the server computer may be a stand-along computing device, or alternatively, a client computing device in the computing system may act as a server computer while also being used by a user. Moreover, in some embodiments, the system 100 may not comprise any server computers. For example, in one embodiment, client computers may be interconnected via the network 104 using peer-to-peer connection methods. In another embodiment, one or more client computers may execute server application programs when required, to act as server computers for a period of time to perform required tasks such as sharing data with other client computing devices, and terminates the execution of the server application programs when the tasks are completed.

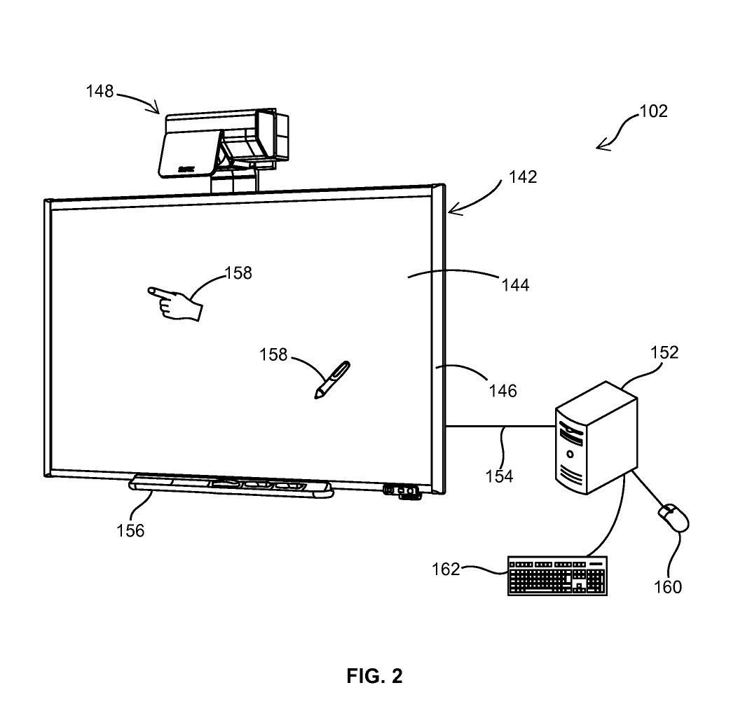

FIG. 2 shows an example of a computer presentation system 102 of the computing system 100, which allows one or more users to inject input such as digital ink, mouse events, commands, etc., into an executing application program, by using one or more pointers 158 such fingers, palms, fists, pen tools, erasers, cylinders or other suitable objects. As shown, the interactive input system 100 comprises a two-dimensional (2D) interactive device in the form of an interactive whiteboard (IWB) 142 mounted on a vertical support surface such as a wall surface or the like. The IWB 142 displays a canvas within which graphic objects are created, displayed and managed.

The IWB 142 comprises a generally planar, rectangular interactive surface 144 that is surrounded about its periphery by a bezel 146. An ultra-short-throw projector 148, such as that sold by SMART Technologies ULC under the name “SMART UX60”, is also mounted on the support surface above the IWB 142 and projects an image, such as for example, a computer desktop, onto the interactive surface 144.

The IWB 142 employs machine vision to detect one or more pointers brought into a region of interest in proximity with the interactive surface 144. The IWB 142 communicates with a general purpose computing device 152 via a universal serial bus (USB) cable 154 or other suitable wired or wireless communication link. The general purpose computing device 152 executes one or more application programs to process the output of the IWB 142 and adjusts image data that is output to the projector 148, if required, so that the image presented on the interactive surface 144 reflects pointer activity. In this manner, the IWB 142, general purpose computing device 152 and projector 148 allow pointer activity proximate to the interactive surface 144 to be recorded as writing or drawing or used to control execution of one or more application programs executed by the general purpose computing device 152.

The bezel 146 is mechanically fastened to the interactive surface 144 and comprises four bezel segments that extend along the edges of the interactive surface 144. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 144.

A tool tray 156 is affixed to the IWB 142 adjacent the bottom bezel segment using suitable fasteners such as for example, screws, clips, adhesive, etc. As can be seen, the tool tray 156 comprises a housing having an upper surface configured to define a plurality of receptacles or slots. The receptacles are sized to receive one or more pen tools as well as an eraser tool that can be used to interact with the interactive surface 144. Control buttons (not shown) are also provided on the upper surface of the tool tray housing to enable a user to control operation of the interactive input system 100.

Imaging assemblies (not shown) are accommodated by the bezel 146, with each imaging assembly being positioned adjacent a different corner of the bezel. Each of the imaging assemblies comprises an image sensor and associated lens assembly that provides the image sensor with a field of view sufficiently large as to encompass the entire interactive surface 144. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 144 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes IR illumination and appears as a dark region interrupting the bright band in captured image frames.

The imaging assemblies are oriented so that their fields of view overlap and look generally across the entire interactive surface 144. In this manner, any pointer brought into proximity of the interactive surface 144 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 152.

The general purpose computing device 152 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, solid-state memory, flash memory, etc.), and a system bus coupling the various computer components to the processing unit. The general purpose computing device 152 may also comprise networking capabilities using Ethernet, WiFi, and/or other suitable network format, to enable connection to shared or remote drives, one or more networked computers, or other networked devices. A mouse 160 and a keyboard 162 are coupled to the general purpose computing device 152.

The general purpose computing device 152 processes pointer data received from the imaging assemblies to resolve pointer ambiguity by combining the pointer data generated by the imaging assemblies, and to compute the locations of pointers proximate the interactive surface 144 using well known triangulation. The computed pointer locations are then recorded as writing or drawing or used an input command to control execution of an application program as described above.

In addition to computing the locations of pointers proximate to the interactive surface 144, the general purpose computing device 152 also determines the pointer types (e.g., pen tool, finger or palm) by using pointer type data received from the IWB 142. The pointer type data is generated for each pointer contact by the DSP of at least one of the imaging assemblies by differentiating a curve of growth derived from a horizontal intensity profile of pixels corresponding to each pointer tip in captured image frames. Specifics of methods used to determine pointer type are disclosed in U.S. Pat. No. 7,532,206 to Morrison, et al., and assigned to SMART Technologies ULC, the content of which is incorporated herein by reference in its entirety.

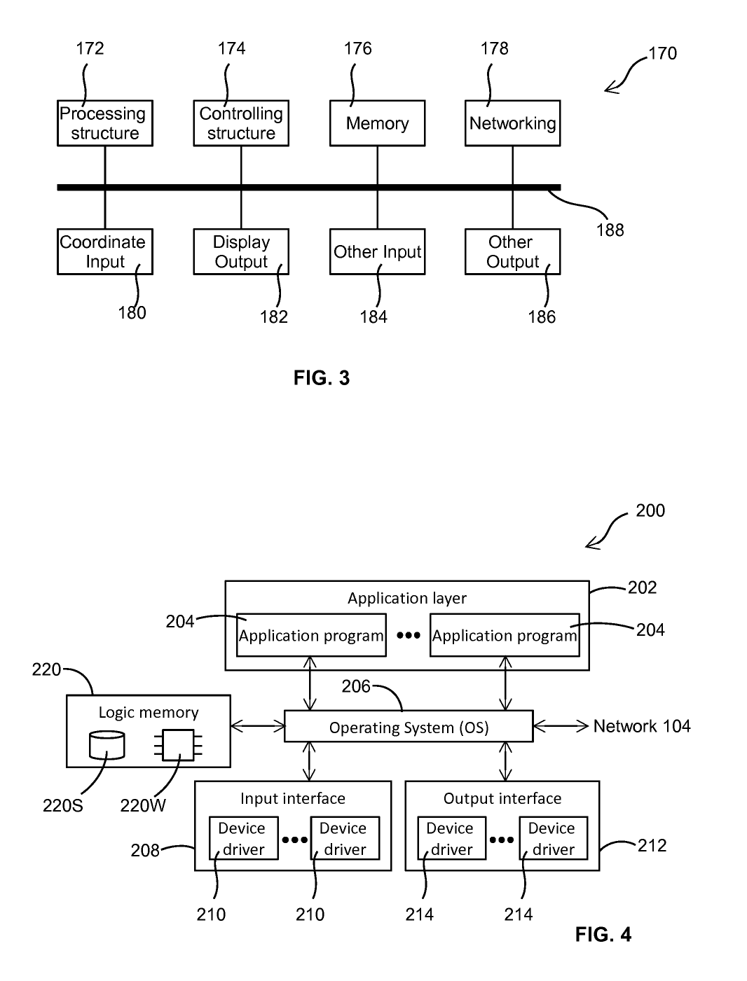

FIG. 3 shows the hardware structure 170 of a computing device 102. The computing device 102 comprises a processing structure 172, a controlling structure 174, memory or storage 176, a networking interface 178, coordinate input 180, display output 182, and other input and output modules 184 and 186, all functionally interconnected by a system bus 188.

The processing structure 172 may be one or more single-core or multiple-core computing processors such as Intel® microprocessors offered by Intel Corporation of Santa Clara, Calif., USA, AMD® microprocessors offered by Advanced Micro Devices of Sunnyvale, Calif., USA, ARM® microprocessors manufactured by a variety of manufactures under the ARM® architecture developed by ARM Ltd. of Cambridge, UK, or the like.

The controlling structure 174 comprises a plurality of controllers, such as graphic controllers, input/output chipsets and the like, for coordinating operations of various hardware components and modules of the computing device 102.

The memory 176 comprises a plurality of memory units accessible by the processing structure 172 and the controlling structure 174 for reading and/or storing data, including input data and data generated by the processing structure 172 and the controlling structure 174. The memory 176 may be volatile and/or non-volatile, non-removable or removable memory such as RAM, ROM, EEPROM, solid-state memory, hard disks, CD, DVD, flash memory, or the like. In use, the memory 176 is generally divided to a plurality of portions for different use purposes. For example, a portion of the memory 176 (denoted as storage memory herein) may be used for long-term data storing, e.g., storing files or databases. Another portion of the memory 176 may be used as the system memory for storing data during processing (denoted as working memory herein).

The networking interface 178 comprises one or more networking modules for connecting to other computing devices or networks via wired or wireless connections such as Ethernet, WiFi®, Bluetooth®, wireless phone channels, ZigBee®, or the like. In some embodiments, parallel ports, serial ports, USB connections, optical connections, or the like may also be used for connecting other computing devices or networks although they are usually considered as input/output interfaces for connecting input/output devices.

The display output 182 comprises one or more display modules for displaying images, such as monitors, LCD displays, LED displays, projectors, and the like. The display output 182 may be a physically integrated part of the computing device 102 (e.g., the display of a laptop computer or tablet), or may be a display device physically separate from, but functionally coupled to, other components of the computing device 102 (e.g., the monitor of a desktop computer).

The coordinate input 180 comprises one or more input modules for one or more users to input coordinate data such as touch-sensitive screen, touch-sensitive whiteboard, trackball, computer mouse, touch-pad, or other human interface devices (HID) and the like. The coordinate input 180 may be a physically integrated part of the computing device 102 (e.g., the touch-pad of a laptop computer or the touch-sensitive screen of a tablet), or may be a display device physically separate from, but functionally coupled to, other components of the computing device 102 (e.g., a computer mouse). The coordinate input 180, in some implementation, may be integrated with the display output 182 to form a touch-sensitive screen or touch-sensitive whiteboard.

The computing device 102 may also comprise other input 184 such as keyboards, microphones, scanners and the like. The computing device 102 may further comprise other output 186 such as speakers, printers and the like.

The system bus 188 interconnects various components 172 to 186 enabling them to transmit and receive data and control signals to/from each other.

FIG. 4 shows a simplified software architecture 200 of a computing device 102. The software architecture 200 comprises an application layer 202, an operating system 206, an input interface 208, an output interface 212 and logic memory 220. The application layer 202 comprises one or more application programs 204 executed or run by the processing structure 102 for performing various tasks. The operating system 206 manages various hardware components of the computing device 102 via the input interface 208 and the output interface 212, manages logic memory 220, and manages and supports the application programs 204. The operating system 206 is also in communication with other computing devices (not shown) via the network 104 to allow application programs 204 to communicate with application programs running on other computing devices. As those skilled in the art appreciate, the operating system 206 may be any suitable operating system such as Microsoft® Windows™, Apple® OS X®, Apple® iOS®, Linux®, Android™ or the like. The computing devices 102 of the computing system 100 may all have the same operating system, or may have different operating systems.

The input interface 208 comprises one or more input device drivers 210 for communicating with respective input devices including the coordinate input 150, and the output interface 212 comprises one or more output device drivers 214 managed by the operating system 206 for communicating with respective output devices including the display output 152. Input data received from the input devices via the input interface 208 is sent to the application layer 202, and is processed by one or more application programs 204. The output generated by the application programs 204 is sent to respective output devices via the output interface 212.

The logical memory 220 is a logical mapping of the physical memory 146 for facilitating the application programs 204 to access. In this embodiment, the logical memory 220 comprises a storage memory area (220S) that is usually mapped to non-volatile physical memory, such as hard disks, solid state disks, flash drives and the like, for generally long-term storing data therein. The logical memory 220 also comprises a working memory area (220W) that is generally mapped to high-speed, and in some implementations volatile, physical memory, such as RAM, for application programs 204 to generally temporarily store data during program execution. For example, an application program 204 may load data from the storage memory area into the working memory area, and may store data generated during its execution into the working memory area. The application program 204 may also store some data into the storage memory area as required or in response to a user's command.

In this embodiment, the computing system 100 executes the processor-readable code of a presentation application program 204 (or simply “a presentation program 204”), e.g., SMART Notebook™ or SMART Notebook™ for iPad® offered by SMART Technologies ULC of Calgary, Alberta, Canada, to facilitate user operations. The presentation program 204 receives user inputs and in response, interacts with user to allow user to manipulate user data, e.g., text, images, digital ink annotation, audio/video clips and the like. The presentation program 204 may store user data to the storage memory as one or more files, e.g., one or more SMART Notebook® files, or as one or more database records, depending on the implementation. The presentation program 204 may also load user data, e.g., a file, from the storage memory to the working memory, and display the content thereof on the screen of the computing device 102. As well known in the art, the process of loading a file from the storage memory to the working memory is usually called “opening a file”, and a file loaded to the working memory is usually called an “opened file”. When a file is opened, generally two copies of the file are maintained, including a working copy in the working memory 220W and a stored copy in the storage memory 220S. The content of the working copy in the working memory 220W may be modified by the user during user manipulation of the file. However, the content of the stored copy in the storage memory 220S often remains unmodified. Therefore, when the opened file is modified, the working copy thereof becomes different from the stored copy.

During user manipulation of the file, the user may initiate a “Save file” command. When a “save file” command is received, the presentation program 204 saves the working copy in the working memory 220W to the storage memory 220S, overwriting the stored copy therein with the content of the working copy. The stored copy is then the same as the working copy.

Usually, when a file is opened, the stored copy is “locked” to restrict the manipulation applicable thereto, e.g., not allowing to be deleted, moved nor renamed. In some embodiments, when a file is opened, it is also “locked” to prevent it from being edited by other application programs or users, or being editable by other application programs or users with suitable conflict-avoidance arrangement.

In a server computer or a client computing device when acting as a server, the application layer 202 generally comprises one or more server application programs 204, which provide server functions for managing network communication with client computing devices, and facilitating collaboration of client computing devices, e.g., managing one or more collaboration sessions, distributing shared content to users in a collaboration session, transferring user inputs from one client computing device to another, and the like.

With above described settings, in this embodiment, a user may execute a presentation program 204 on a computing device to open a file from the storage memory 220S or create a new file. When a new file is created, the working copy thereof is considered different from the stored copy thereof until the file is saved to the storage memory 220S.

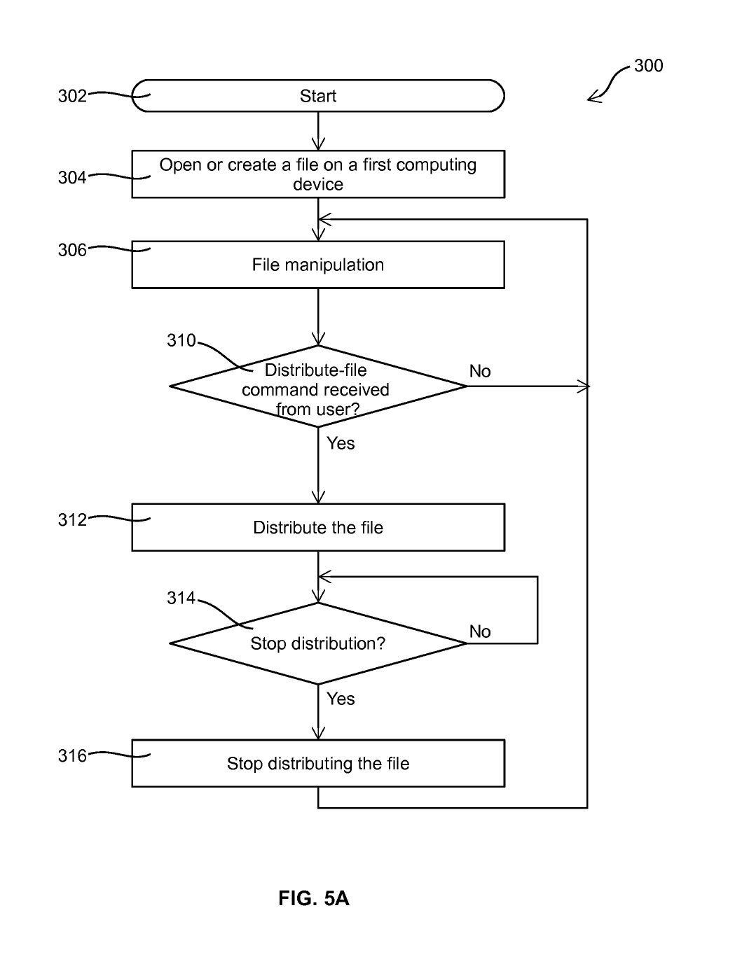

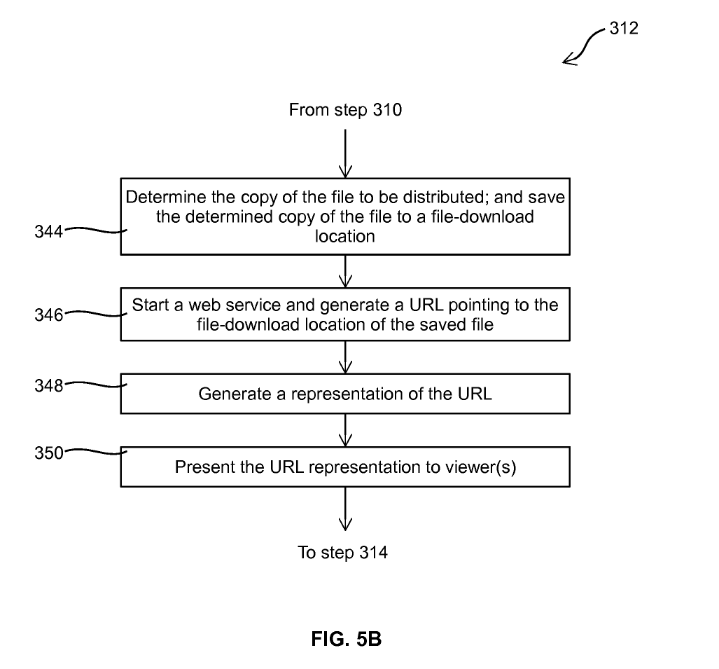

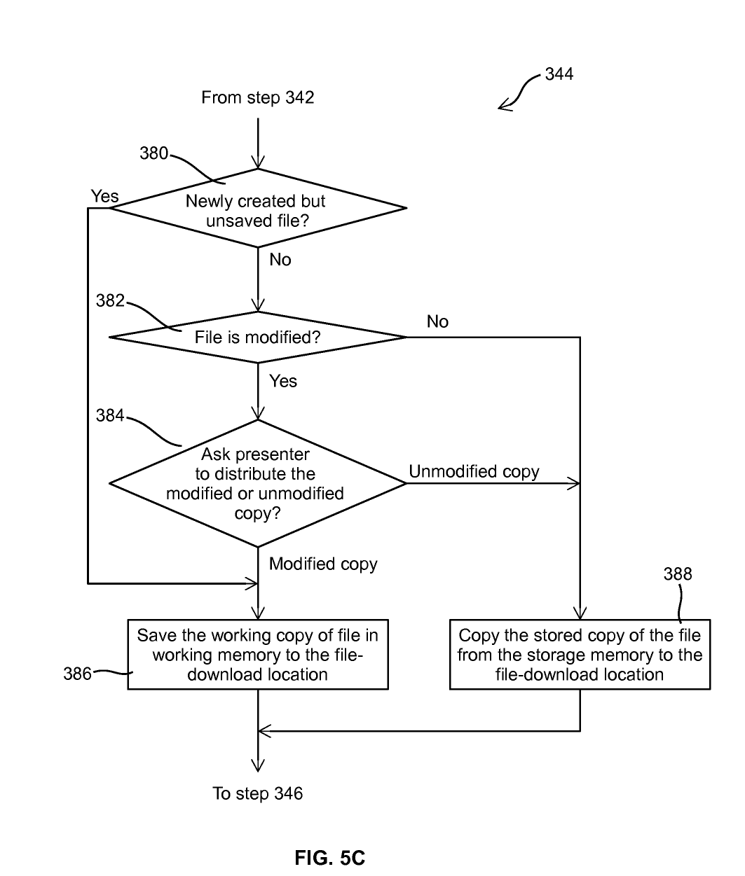

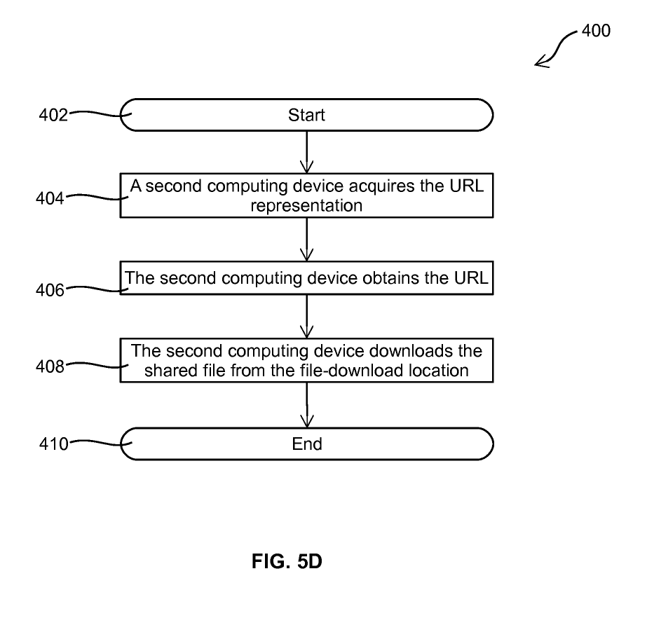

The user may distribute the opened file, being the file opened from the storage memory 220S or the newly created file, to other computing devices without closing the opened file. In other words, the user may distribute the opened file to other computing devices while the file is still “locked”. FIGS. 5A to 5C shows a flowchart illustrating the steps of a process 300 for distributing an opened file from a computing device to one or more other computing devices in the system 100.

As shown in FIG. 5A, the process starts when the presentation program 204 is executed on a first computing device (step 302). At step 304, the presentation program 204, in response to a command from the user of the first computing device, opens an existing file by loading the file from a storage memory into the working memory of the first computing device. Alternatively, the presentation program 204 may create a new file.

At step 306, the user may initiate inputs to manipulate the opened file, for example, browsing through its contents, adding, modifying or deleting the content of the file, and the like. As will be described in more detail later, the presentation program 204 allows the user to initiate a Distribute-file command to distribute the working copy or the stored copy of the file currently opened in the presentation program 204 to other computing devices. At step 310, the presentation program 204 checks if a Distribute-file command is received. If no Distribute-file command is received, the process loops back to step 306 for file manipulation. If a Distribute-file command is received at step 310, the presentation program 204 distributes the opened file (step 312).

FIG. 5B shows the detail of step 312 of distributing the opened file for download. At step 344, the presentation program 204 determines which one of the working and stored copies of the file shall be distributed, and saves the determined copy of the file to a predetermined file-download location in the system. In this embodiment, the predetermined file-download location is a folder of the storage memory local to the first computing device, and is generally a location or folder different from the location or folder storing the stored copy of the file.

FIG. 5C shows the detail of step 344. The presentation program 204 first check if the opened file is a newly created file having never been saved (step 380). If yes, the opened file only has a working copy in the working memory, and has no stored copy in the storage memory; and the working copy thereof is considered different from the stored copy thereof. The process therefore goes to step 386 to save the working copy of the opened file in the working memory to the file-download location.

If the opened file is not a newly created file, or is a newly created file that has been saved prior to the Distribute-file command, the presentation program 204 then checks if the file has been modified (step 382) since last file-saving operation. Herein, the term “file having been modified” or the term “modified file” refers to the state that the file has been modified from its last saved content, and the modification of the file has not yet been saved to the storage memory such that the working copy thereof is different from the stored copy thereof.

If it is determined that the file has been modified from its last saved content, the working copy of the opened file in working memory is then different from the stored copy thereof in storage memory. The presentation program 204 then asks the user of the first computing device whether the user would like to distribute the modified copy, i.e., the working copy of the file in the working memory, or the unmodified copy, i.e., the stored copy of the file in the storage memory (step 384). If the user decides to distribute the modified copy, the presentation program 204 then saves the working copy of the opened file in the working memory to the file-download location (step 386). The stored copy of the opened file remains different from the working copy. The process then goes to step 346.

If at step 384, the user decides to distribute the unmodified copy, the presentation program 204 then copies the stored copy of the file from the storage memory to the file-download location (step 388). Therefore, the modified copy of the opened file is not distributed. The process then goes to step 346.

Similarly, if at step 382, it is determined that the currently open file is not yet modified, the presentation program 204 then copies the file from the storage memory to the file-download location (step 388). The process then goes to step 346.

Referring back to FIG. 5B, the presentation program 204 then starts a web service and generates a file-download location identifier, e.g., a Universal Resource Locator (URL) pointing to the location of the saved file (step 346). The presentation program 204 further generates a representation of the file-download URL, e.g., a Quick Response Code (QR code), a type of matrix barcode or two-dimensional barcode trademarked by DENSO WAVE INCORPORATED, encoding the URL (step 348).

At step 350, the presentation program 204 presents the generated URL representation to viewers, e.g., by displaying the QR code on the presenter's screen. The process then goes to step 314.

Referring back to FIG. 5A, at step 314, if no Stop-distribution command is received, the process waits for a Stop-distribution command (i.e., looping to itself) while continuing allowing other computing devices to download the shared file. If, at step 314, a Stop-distribution command is received, the presentation program 204 stops distributing the opened file (step 316) by deleting the file from the file-download location, and stopping the web service. The process then loops to step 306.

Although not shown in FIG. 5A, the user of the first computing device may initiate a Close-file command to close the opened file. When closing the opened file, the presentation program 204 checks if the content of the file is changed. If the content of the file is changed, the presentation program 204 asks the user whether or not the file shall be saved, and save the file after the user confirms to do so. If the file is currently in distribution for download, the presentation program 204 also stops distributing the file as described above before closing it.

FIG. 5D shows a flowchart illustrating steps of a process 400 performed by a second computing device for receiving a file distributed by the first computing device as illustrated in FIGS. 5A to 5C. The process starts when the first computing device starts to distribute an opened file (step 402). At step 404, the second computing device acquires the URL representation, e.g., by scanning the presented QR code using an imaging device or component associated with the second computing device. The second computing device then decodes the URL representation, to obtain the URL (step 406), and accesses the file-download location to download the file (step 408). The file currently opened in the first computing device is thus distributed to the second computing device.

Other computing devices may follow the same procedure to download the file.

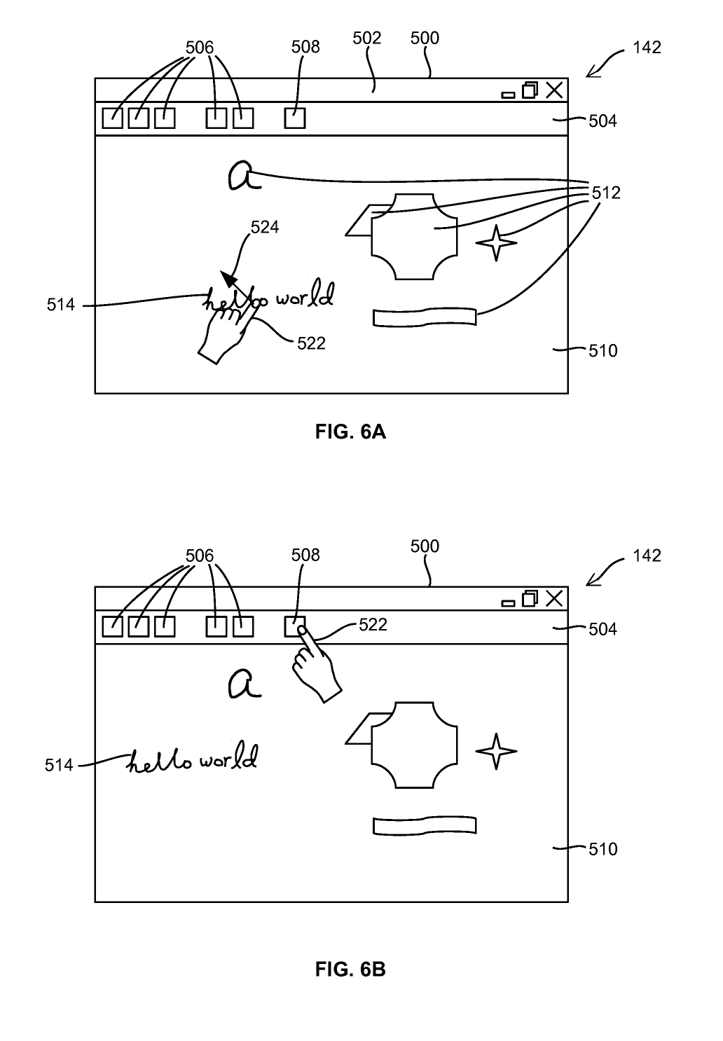

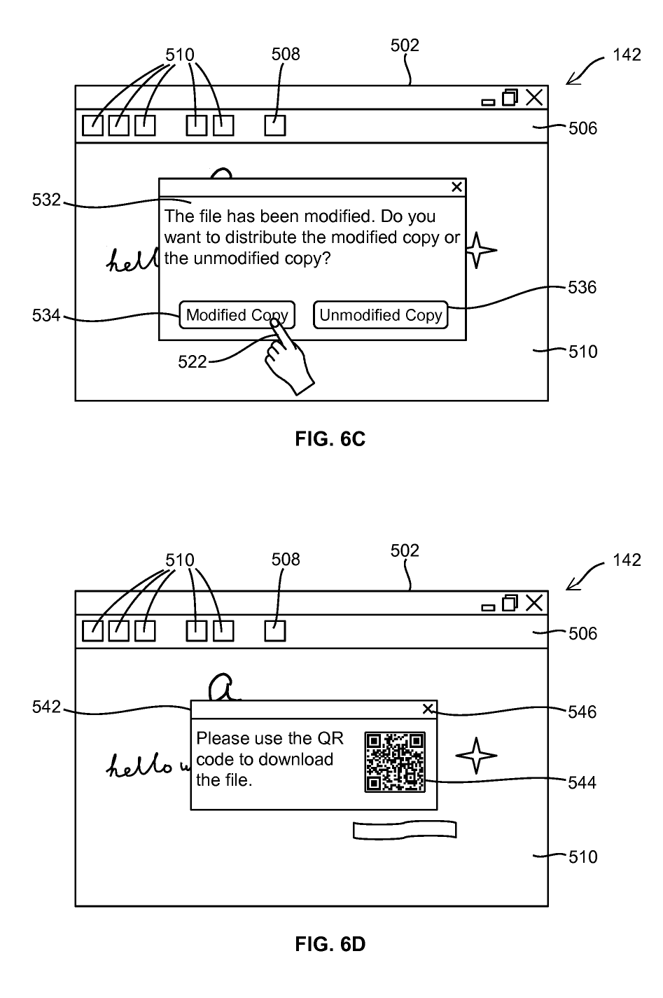

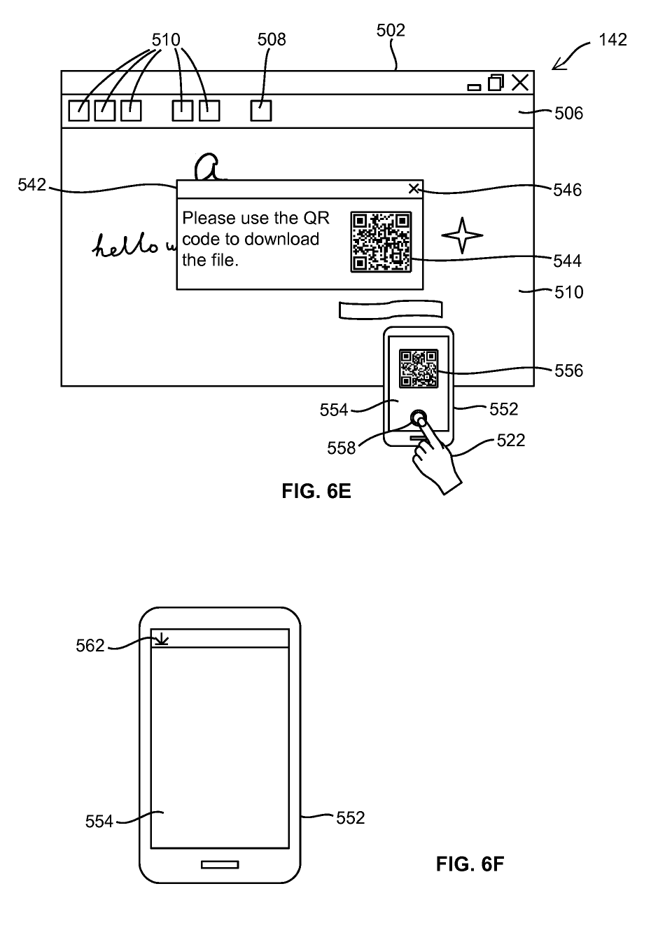

FIGS. 6A to 6F illustrate an example of distributing an opened file. In this example, a user User_A executes a SMART Notebook™ presentation program 204 running on a first computing device, and opens a file “File_A.notebook”. As shown in FIG. 6A, the presentation program 204, when running, displays a window 502 on the touch-sensitive display 142 of the first computing device. The window 500 comprises a title bar 502, a toolbar 504 having a plurality of tool buttons 506 and 508, a canvas 510 for accommodating graphic objects 512 and 514.

The user User_A may manipulate the opened file “File_A.notebook” and graphic objects 512 therein. For example, as illustrated in FIG. 6A, the user User_A may apply a suitable pointer, e.g., a finger 522, on the touch-sensitive display 142 overlapping a graphic object 514 and slide the pointer 522 along a direction indicated by the arrow 524. As a result, as shown in FIG. 6B, the graphic object 514 is moved to a new location on the canvas 510. The opened file is now modified in the working memory, and the working copy of the file in the working memory is different from the stored copy thereof in the storage memory.

The presentation program 204 provides in its toolbar 504 a “Distribute-file” tool button 508. As shown in FIG. 6B, the user User_A uses the pointer 522 to tap the “Distribute-file” tool button 508. As the file “File_A.notebook” in window 502 has been modified, i.e., the graphic object 514 has been moved, the presentation program 204 displays a dialog box 532 asking whether User_A would like to distribute the modified or unmodified copy of the file, and provides therein a “Modified Copy” button 534 for distributing the modified copy and an “Unmodified Copy” button 536 for distributing the unmodified copy, as shown in FIG. 6C. In this example, User_A uses the pointer 522 to tap the “Modified Copy” button 534. As a result, the working copy of the opened file is saved to a predetermined file-download location. In this example, the working copy of the opened file is saved to the file-download location using a randomly generated file name with the same file extension, e.g., “QDTGR87585.notebook”.

The presentation program 204 then starts a web service for other users to download the file. In this example, the web service allows users, or more precisely, other computing devices including other computing devices operated by User_A, to download the file using the Hypertext Transfer Protocol (HTTP) protocol. Of course, those skilled in the art appreciate that, in some alternative embodiments, the web service may allow other computing devices to download files using other suitable protocols such as the File Transfer Protocol (FTP).

The presentation program 204 generates a URL pointing to the file-download location, e.g., “http://templink/QDTGR87585.notebook”, and then generates a representation of the URL. In this example, the presentation program 204 generates a QR code. As shown in FIG. 6D, the presentation program 204 pops up another dialog box 542 showing the generated QR code 544, and waits for other computing devices to capture the QR code 544 to access and download the file from the URL represented by the QR code 544. The user User_A may tap the “Close” button 546 of the dialog box 542 to close the dialog box and stop the file-download web service to stop distributing the file.

As shown in FIG. 6E, a user, being User_A or another user, positions a second computing device 552, such as a smartphone, having an imaging device (not shown) and a screen 554, in front of the display 142, and pointing the imaging device towards the QR code displayed on the display 142. The second computing device 552 executes the processor-readable code of an image capturing application program displaying the image 556 to be acquired or captured, and a “Capture-image” command button 558. As shown, the user User_A uses the pointer 522 to tap the button 558. In response, the second computing device 552 scans, captures or otherwise acquires an image of the QR code 544.

After capturing the image of the QR code 544 the application program, running on the second computing device 552, automatically decodes the captured QR code image and obtains the URL. Then, the second computing device 552 automatically accesses the obtained URL to download the file “QDTGR87585.notebook”. In this example, the second computing device 552 accesses the obtained URL via the image capturing application program. However, in an alternative embodiment, the second computing device 552 may launch another application program such as a browser and passes the obtained URL thereto to access the URL and download the file.

As shown in FIG. 6F, after the file “QDTGR87585.notebook” is downloaded, an icon 562 is displayed on the screen 554 of the second computing device 552 to notify the user that the file-downloading operation has completed. The user of the second computing device 552 may then manipulate the downloaded file thereon.

Those skilled in the art appreciate that other embodiments are readily available. For example, in an alternative embodiment, the presentation program 204 may be an application program module in the form of an add-on of a third-party program such as Microsoft® Word, PowerPoint®, Excel®, Adobe® Acrobat® or the like.

In an alternative embodiment, the file-download location may a folder of a storage memory remote to the first computing device, e.g., a folder in the storage memory of a server computer.

Although, in examples of 6A to 6F, the second computing device 552 comprises an imaging device integrated thereon, in an alternative embodiment, the second computing device is functionally coupled to an imaging device separated therefrom. In this embodiment, the user of the second computing device is required to point the imaging device towards the QR code 544 displayed on the display 142 to acquire the URL representation, i.e., an image of the QR code 544.

Although in above embodiments, the URL representation is in the form of a QR code, in some alternative embodiments, the URL representation may be in other suitable forms, e.g., a barcode, a character string of the URL, or the like.

In above embodiments, each computing device 102 has a separate, predetermined file-download location for distributing opened files. In an alternative embodiment, all computing devices 102 use a same, predetermined file-download location in the system 100, e.g., a shared folder in a memory device of the system 100. In another embodiment, the system 100 does not comprise any predefined file-download location. Rather, each computing device 102, when distributing an opened file, dynamically determine or designate a file-download location, e.g., by creating a temporary folder for saving the file to be distributed, or by dynamically designate an existing folder for saving the file to be distributed. In yet another embodiment, when a computing device 102 is to distribute an opened file, the folder that the opened file was opened therefrom is used as the file-download location.

In an alternative embodiment, the presentation program 204 running on the first computing device is an application program, e.g., SMART Meeting Pro™ offered by SMART Technologies ULC of Calgary, Alberta, Canada, that shares the screen images of the first computing device to other computing devices (denoted as viewer computers) in the system 100 during a collaboration session. The presentation program 204 collaborates with programs running on viewer computers in system 100 to facilitate user collaboration. In this embodiment, the content of the opened file is distributed to viewers as one or more images. The file itself, however, is not distributed to viewers.

Herein, a collaboration session is the time period during which a plurality of users are collaboratively working together via a computer network system, such as conducting a presentation, a brainstorming work, a collaborative design or document preparation, or the like.

The computer network system may monitor a collaboration session, e.g., via a session manager, and schedule relevant tasks such as starting the collaboration session for allowing users to join, verifying user identities, establishing network connections between one or more collaboration servers and client computing devices, transferring data and commands between servers and client computing devices, terminating the collaboration session and associated network connections, and the like.

In this embodiment, the user of the first computing device, after sharing the screen images to viewer computers, may also allow users of the viewer computers to manipulate the opened file. System 100 responds to such commands in known manner and implements suitable version control, conflict avoiding/solving, media sharing methods in known manner, the details of which are omitted here.

When the user of the first computing device start to distribute an opened file, the presentation program 204 displays a QR code representing the file-download URL as described above. In addition to the display of the QR code, the presentation program 204 also send a command to viewer computers in the system 100. In response, the presentation programs 204 running on viewer computers display a clickable link in the form of text or image, which may be clicked or tapped by the respective users to access the URL and download the file. In this embodiment, the URL representation present to viewers comprises both the link displayed on viewer computers and the QR code displayed on the first computing device.

In yet another embodiment, the URL representation only comprises a link displayed on the viewer computers.

In still another embodiment, instead of displaying a clickable link on viewer computers, a clickable button is displayed on viewer computers. Users of the viewer computers may click or tap the button to access the URL and download the file.

In some alternative embodiments, the computer network system may not monitor the collaboration session, and may start tasks only when needed. For example, in one embodiment, a presenter may use a presentation computing device to conduct a presentation to a group of audiences without establishing network connections with any audiences' computing devices. In this embodiment, the collaboration session starts with only one computing device. An audience's computing device joins the collaboration session and establishes network connection with the presenter's computing device when the presenter starts to distribute an opened file to audiences. After establishing network connection with the presenter's computing device, the audience's computing device downloads the file as described above.

In an alternative embodiment, when the user of the first computing device starts the distribution of an opened file that has been modified, the presentation program 204 does not ask the user which copy of the modified file shall be distributed. Rather, the presentation program 204 automatically saves the working copy of the modified file to the file-download location such that other computing devices can always download the modified content of the file. Of course, those skilled in the art appreciate that, in some embodiments, when the user of the first computing device starts the distribution of an opened file, the stored copy is always distributed regardless whether or not the filed has been modified.

In above embodiments, after the user of the first computing device starts distribution of the working copy of an opened file, the presentation program 204 running thereon waits for other computing devices to download the file. Consequently, the presentation program 204 running on the first computing device is “paused” at this state, and the user can no longer manipulate the file through the presentation program 204 until the file distribution process stops. However, if the stored copy of the file is distributed, the presentation program 204 running on the first computing device is not “paused”, and the user can still manipulate the file through the presentation program 204 during the file distribution.

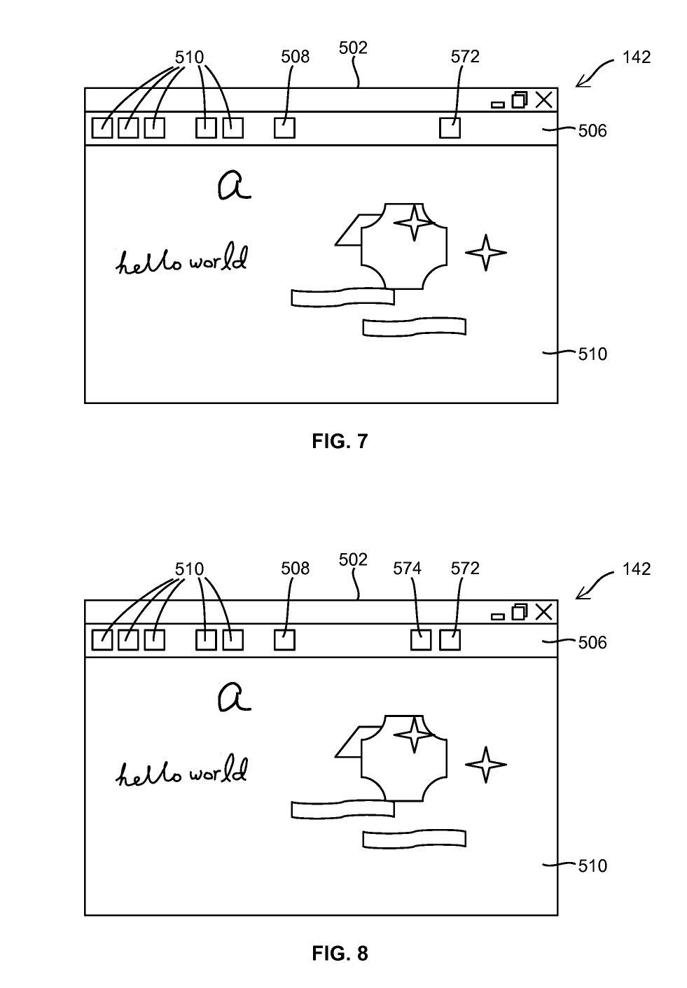

In an alternative embodiment, after the user of the first computing device starts distribution of an opened file, regardless whether the working copy or the stored copy is distributed, the presentation 204 program running thereon allows the user to continue manipulation of the file. FIG. 7 shows an example. As shown, after the user taps the “Distribute-file” tool button 508, and the file distribution process starts as described above, the presentation program 204 displays a “Stop file distribution” tool button 572 on the toolbar 506. The user of the first computing device is then able to continue manipulation of the file while other computing devices are downloading the file at the file-download location. The user may tap or click the “Stop file distribution” tool button 572 to stop file distribution.

In yet another embodiment, after the user of the first computing device starts file distribution, the presentation program 204 running thereon displays a “Stop file distribution” tool button 572 and a “Re-distribute file” tool button 574 on the toolbar 506, and allows the user to continue manipulation of the file while other computing devices are downloading the file at the file-download location. The user may modify the file, and tap or click the “Re-distribute file” tool button 574 to save the working copy of the file to the file-download location. In this embodiment, if there is any ongoing file downloading activity during the re-saving of the file at the file-download location, the ongoing file downloading activities are automatically restarted. In another embodiment, the ongoing file downloading activities fail when the file being downloaded is re-saved. Users of the computing devices that failed to download the file are prompted to restart the file-downloading process.

In another embodiment, the “Re-distribute file” tool button 574 is not presented after an opened file is set to distribute. Rather, if the working copy of the opened file has been distributed, the presentation program 204 running on the first computing device automatically re-saves the working copy of the file to the file-download location periodically, or, alternatively, after modification is made to the opened file.

In an alternative embodiment, the predetermined file-download location may be customizable by one or more users.

In above embodiments, the web service for downloading the file is running on the first computing device. However, in an alternative embodiment, the web service for downloading the file is running on a server of the system 100.

In an alternative embodiment, when the process of distributing an opened file starts, a file-distribution service is started. Rather than using HTTP or FTP protocol, the file-distribution service uses another suitable file sharing method, e.g., by sharing the file-download folder using the traditional Windows™ folder sharing method, for distributing the file.

As described above, the computing devices 102 may be interconnected to each other via the networking interface 178 using any suitable wired or wireless connections such as Ethernet, WiFi®, Bluetooth®, wireless phone channels, ZigBee®, parallel ports, serial ports, USB connections, optical connections, or the like for distributing an opened file from a first computing device to one or more second computing devices. While the first computing device may be a mobile device or a computing device with less mobility, such as a desktop computer, and may use wired or wireless connections for distributing an opened file to other computing device, the second computing devices, on the other hand, are often mobile devices such as smartphones or tablets, and may more conveniently use wireless connections for connecting to the web service and downloading the distributed file.

Although embodiments have been described above with reference to the accompanying drawings, those of skill in the art will appreciate that variations and modifications may be made without departing from the scope thereof as defined by the appended claims.

What is claimed is:

1. A computerized method of distributing an opened file on a first computing device, the method comprising:
on the first computing device, upon receiving a command to distribute the file,
starting a file-distribution service for downloading a copy of the file from a file-download location;
generating a file-download location identifier, the file-download location identifier indicating the file-download location;
generating a representation of the file-download location identifier; and
presenting the representation for distributing the opened file.

2. The method of claim 1 further comprising:
on a second computing device,
acquiring the representation;
obtaining said file-download location identifier from the representation; and
downloading said copy of the file from the file-download location indicated by the file-download location identifier.

3. The method of claim 1 wherein the file-distribution service is a web service using the Hypertext Transfer Protocol (HTTP) or File Transfer Protocol (FTP) protocol; and wherein the file-download location identifier is a Universal Resource Locator (URL) of the file-download location.

4. The method of claim 1 wherein the representation of the file-download location identifier is a QR code; and wherein said acquiring the representation further comprises:
acquiring the QR code using an imaging device.

5. The method of claim 1 wherein said opened file comprises at least a working copy and a stored copy, and the method further comprising:
saving one of the working copy and the stored copy to the file-download location.

6. The method of claim 5 wherein said saving one of the working copy and the stored copy to the file-download location comprises:
determining whether the working copy is different from the stored copy; and
if the working copy is different from the stored copy, saving a copy of the working copy to the file-download location.

7. The method of claim 6 further comprising:
on the first computing device, after a copy of the file has been saved to the file-download location,
determining that the file has been modified after said copy of the file has been saved to the file-download location; and
saving the working copy of the file to the file-download location.

8. The method of claim 1 wherein the file-download location is a file folder in a memory local to the first computing device or a file folder in a memory remote to the first computing device.

9. A computing system for distributing an opened file, comprising:
at least a first computing device, said first computing device comprising:
a memory;
a networking structure; and
a processing structure functionally coupled to said memory and networking structure, wherein said processing structure executes computer-executable code for:
receiving a command to distribute the file;
starting a file-distribution service for downloading a copy of the file from a file-download location;
generating a file-download location identifier, said file-download location identifier indicating the file-download location;
generating a representation of the file-download location identifier; and
presenting the representation for distributing the opened file.

10. The system of claim 9 further comprising at least a second computing device, said at least a second computing device comprising:
a memory;
a networking structure; and
a processing structure functionally coupled to said memory and networking structure; wherein said processing structure executes computer-executable code for:
acquiring the representation;
obtaining said file-download location identifier from the representation; and
downloading said copy of the file from the file-download location indicated by the file-download location identifier.

11. The system of claim 9 wherein the representation of the file-download location identifier is a QR code; and wherein said acquiring said representation further comprises:
acquiring the QR code using an imaging device.

12. The system of claim 9 wherein said opened file comprises at least a working copy and a stored copy; and wherein the processing structure of the first computing device further executes computer-executable code for:
saving one of the working copy and the stored copy to the file-download location.

13. The system of claim 12 wherein said saving one of the working copy and the stored copy to the file-download location comprises:
determining whether the working copy is different from the stored copy; and
if the working copy is different from the stored copy, saving a copy of the working copy to the file-download location.

14. The system of claim 13 wherein the processing structure of the first computing device further executes computer-executable code for:
after a copy of the file has been saved to the file-download location,
determining that the file has been modified after said copy of the file has been saved to the file-download location; and
saving the working copy of the file to the file-download location.

15. A non-transitory computer-readable storage device comprising computer-executable instructions for distributing an opened file, wherein the instructions, when executed, cause a first processor to perform actions comprising:
starting a file-distribution service for downloading a copy of the file from a file-download location;
generating a file-download location identifier, said file-download location identifier indicating the file-download location;
generating a representation of the file-download location identifier; and
presenting the representation for distributing the opened file.

16. The computer-readable storage device of claim 15 further comprising computer-executable instructions, when executed, cause a second processor to perform actions comprising:
acquiring the representation;
obtaining said file-download location identifier from the representation; and
downloading said copy of the file from the file-download location indicated by the file-download location identifier.

17. The computer-readable storage device of claim 15 wherein the file-distribution service is a web service using the HTTP or FTP protocol; and wherein the file-download location identifier is a URL of the file-download location.

18. The computer-readable storage device of claim 15 wherein the representation of the file-download location identifier is a QR code; and wherein said acquiring said representation further comprises:
acquiring the QR code using an imaging device.

19. The computer-readable storage device of claim 15 wherein said opened file comprises at least a working copy and a stored copy; and wherein the instructions, when executed, cause the first processor to perform further actions comprising:
determining whether the working copy is different from the stored copy; and
if the working copy is different from the stored copy, saving a copy of the working copy to the file-download location.

20. The computer-readable storage device of claim 19 wherein the instructions, when executed, cause the first processor to perform further actions comprising:
after a copy of the file has been saved to the file-download location,
determining that the file has been modified after said copy of the file has been saved to the file-download location; and
saving the working copy of the file to the file-download location.
